(19) United States
(12) Patent Application Publication
(10) Pub. No.: US 2012/0117959 A1
(43) Pub. Date: May 17, 2012

(54) Remote Control Circuit for a Hydraulically Operated Device

(75) Inventor: Randy D. Lewkoski, Shiner, TX (US)

(73) Assignee: ILLINOIS TOOL WORKS INC., Glenview, IL (US)

(21) Appl. No.: 13/163,882

(22) Filed: Jun. 20, 2011

Related U.S. Application Data
(60) Provisional application No. 61/414,637, filed on Nov. 17, 2010.

(51) Int. Cl. F16D 31/02

(52) U.S. Cl. 60/431

(57) ABSTRACT

A flow circuit enables an ROV to control a submersible machine having three motors without electronics, and using only two fluid flow lines between the machine and the ROV. The circuit configures two of the motors to operate in parallel, and a switch valve between the parallel motors and the third motor. A detection circuit on the machine detects the presence or absence of a back pressure in the controlling lines. If a back pressure is detected, the circuit on the machine directs fluid to either of the motors in parallel, or the third motor, thereby enabling the operator to select which motor or motors to operate by creating or releasing a back pressure.

The applicant claims priority from his provisional application, which was filed on Nov. 17, 2010 and assigned Ser. No. 61/414,637. The present invention relates to hydraulically operated remote devices such as subsea machines for cutting or repairing underwater pipes.

### BACKGROUND OF THE INVENTION

Offshore oil wells stand on cylindrical legs mounted on the ocean floor. At the end of the well's life the platform is taken down and the legs are cut off near the floor. During its useful life, liquefied oil is transferred from the site to the shoreline by means of a piping that extends along the ocean floor to the shore. Such piping requires periodic repair as a result of shifting of tectonic plates or interference by a ship anchor or the like. The legs of such platforms and the pipes may be as deep as ten thousand feet below sea level such that the machines needed to cut or repair them must be entirely remotely operable. Machines that cut out a defective length of submerged pipe are generally hydraulically operated and the hydraulic pressure for operating such devices is generated from a remotely operated vehicle (ROV) which in turn may be controlled from the surface or by an operator in an independent submersible.

A submersible wire saw suitable for cutting pipes and underwater vertical supports includes a mounting frame with clamps for clamping around the circumference of a pipe or vertical leg. Also attached to the mounting frame is a moveable wire saw that applies a diamond embedded wire against the surface to be cut. The wire saw includes a hydraulic motor for rotating the diamond embedded wire which moves in one direction only. In addition to the motor that rotates the wire, the machine includes a second motor that advances the rotating wire against the surface to be cut. A third hydraulic device operates the clamps such that there are three separate motors needed to operate a submersible wire saw. To provide hydraulic fluid to the three motors of a submersible wire saw, it is currently the practice to provide three pairs of hydraulic fluid lines that extend between the ROV and the wire saw machine. Consequently, there are a total of six flexible hydraulic lines extending between the ROV and the machine, any one of which may inadvertently become entangled around the machine or the ROV and cause serious complications.

It is possible to reduce the number of hydraulic lines running between the ROV and the machine by providing for electrically operated valves. Such valves, however, also require an umbilical electric cord and must operate under extreme pressures of deep depths and are subject to failure. Alternately, external controls can be provided on the machine which are manually operated by the ROV. Such manually operated controls also have risk of failure or damage to either the ROV or the machine. It would therefore be desirable to provide a hydraulic circuit which would allow the ROV to operate all the motors of the submersible machine utilizing only one pair of hydraulic hoses and without requiring an electronic umbilical cord.

### BRIEF DESCRIPTION OF THE INVENTION

Briefly, the present invention in embodied in a hydraulic circuit for controlling a submerged hydraulically operated machine from a remote location, such as an ROV, where a source of pressurized hydraulic fluid is provided in the remote location. The hydraulically operated machine has a first, second, and third hydraulically operated motors, the first of the motors being rotary and operable in only one direction, the second of the motors being operable in two directions, the first and second motors requiring simultaneous operation, and the third of the motors being operable in two directions and operable only when the first and second motors are not operable.

In accordance with the invention, a first fluid line and a second fluid line extend between the source of pressurized fluid at the remote location, and the device. A first valve adjacent the source of pressurized fluid selectively directs pressurized fluid to one of the first line and the second line wherein pressurized fluid directed to the first line is returned in the second line and pressurized fluid directed to the second line is returned in the first line. Also adjacent the source of pressure is a first means for forming a back pressure in the first line and a first means for selectively engaging and disengaging the first means for forming a back pressure. Similarly, a second means is provided for forming a back pressure in the second line and a second means is provided for selectively engaging and disengaging the second means for forming a back pressure.

The remainder of the circuit is positioned in the hydraulically operated device and includes a first sensor means for sensing a back pressure in one of the first line and the second line. Also, the first motor and the second motor are configured in parallel between a third line and a fourth line and a subcircuit is positioned between the third and fourth lines for directing pressurized fluid through the first motor for rotation in one direction only. A fifth and a six fluid flow lines connect to the third motor. A first fluid switching means on the first line selectively switches the flow of pressurized fluid from the first line to one of the third line and the fourth line. Similarly, a second fluid switching means on the second line selectively switches pressurized fluid from the second line to one of the fourth line and the sixth line.

The first means for selectively switching is adapted to direct pressurized fluid in the first fluid line to one of the third and fifth line response to the detection of a back pressure, and directing pressurized fluid from the first fluid line to the other of the third line and the fifth line in response to the absence of a back pressure. In similar fashion, the second means for selectively switching directs fluid flow from the second fluid line to one of the fourth line and the sixth line in response to detection of a back pressure and directs pressurized fluid from the second fluid line to the other of the fourth line and the sixth line in response to the absence of the detection of a back pressure wherein the first and second switching means are actuated in response to a back pressure in one of the first line and the second line.

### BRIEF DESCRIPTION OF THE DRAWINGS

A better understanding of the invention will be had after a reading of the following detailed description taken in conjunction with the drawings wherein:

FIG. 1 is an isometric view of a submersible cutting machine operable by an ROV;

FIG. 2 is a second isometric view of the machine shown in FIG. 1; and

FIG. 3 is a schematic diagram of the hydraulic circuit between the ROV and the submersible machine depicted in FIG. 1.

### DETAILED DESCRIPTION OF PREFERRED EMBODIMENT

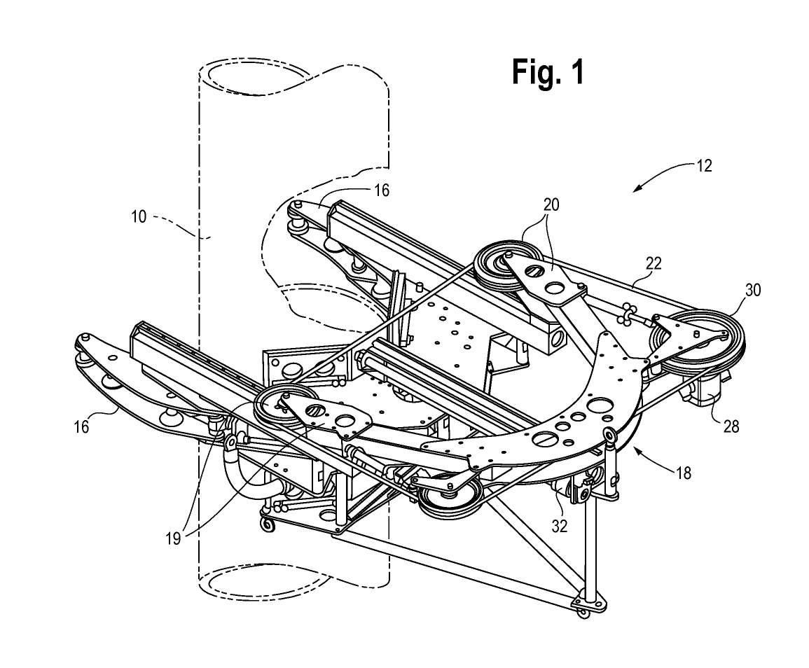

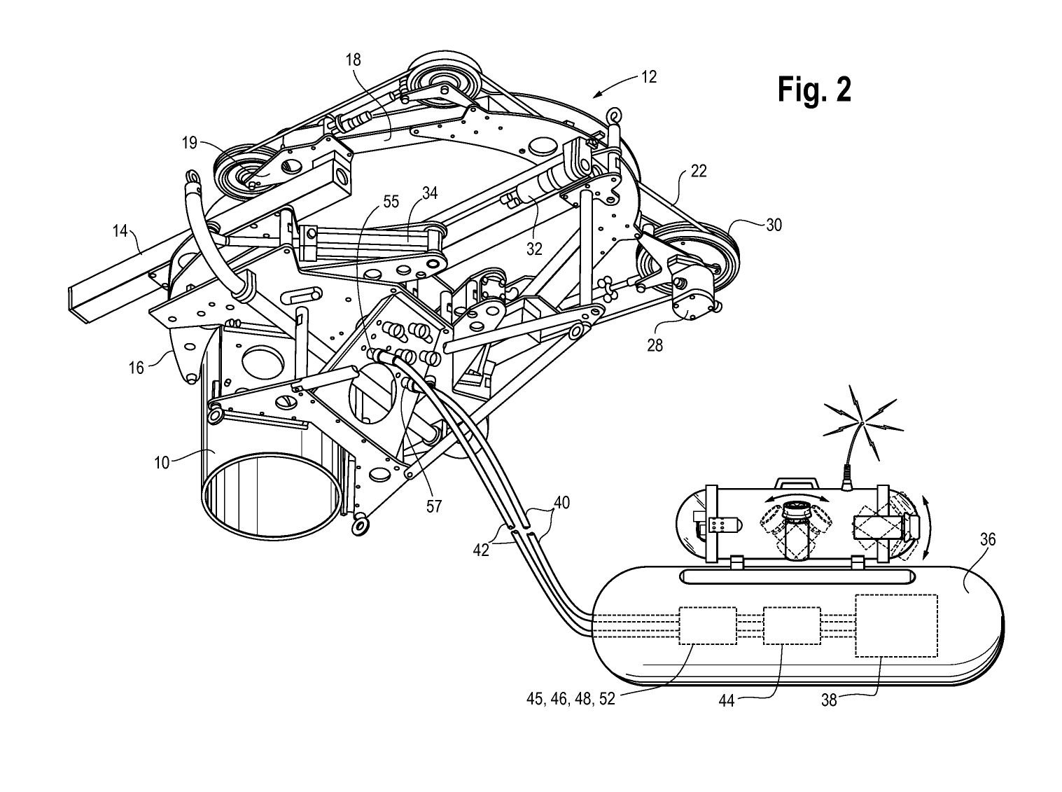

Referring to FIGS. 1 and 2, a deep water well includes a platform, not shown, supported by a plurality of vertical underwater pillars one of which 10 is depicted. When the drilling platform has completed its useful life, the platform is removed by cutting the pillars 10 near the ocean floor using a machine 12. The machine 12 includes a body 14, and attached to the body 14 is at least one pair of clamps 16 for grasping around the circumference of the pillar 10. Also mounted on the body 14 is a U-shaped frame 18 having outer ends 19, 20. The frame 18 is moveable along slides oriented such that the outer ends 19, 20 move perpendicular to the length of the pillar 10 and along opposite sides thereof. A diamond wire 22 is rotatably mounted on the frame 18 by a plurality of wheels such that a portion of the diamond wire 22 will extend across the outer ends 19, and will cut the pillar 10 as the frame is moved perpendicular thereto.

Referring to FIGS. 1, 2 and 3, the machine 12 includes a first motor 28 that rotates a drive wheel 30 for rotating the diamond wire 22, a second motor 32 for advancing or retracting the frame 18 towards or away from the pillar 10, and a third motor 34 for moving the clamps 16 from an open position to a closed position for grasping the pillar 10 and for moving the clamps from a closed position to an open position for releasing the pillar 10. In normal operation, a machine 12 suitable for cutting a subsurface pillar 10 the first motor 28 is only operable in only one direction for moving the diamond wire 22 while the second motor 32 must be operable in two directions, for advancing the frame 18 against the pillar 10, or retracting the frame away from the pillar 10. The first and second motors are normally operated together, that is, the diamond wire blade 22 is moving while the second motor 32 advances or retracts the frame 18. On the other hand, the third motor 34 is normally operated for clamping and releasing the clamps 16 when neither the first nor second motors are operable.

The operation of the machine 12 is carried out by an ROV 36, on which is mounted a compressor 38 for providing a source of pressurized hydraulic fluid. Pressurized hydraulic fluid is moved to the machine 12 and returned to the ROV 36 by means of a first and second hydraulic lines 40, 42. The lines 40, 42 are normally flexible in nature and extend through the open water having a first end connected to the ROV 36 and a second end connected to the machine 12.

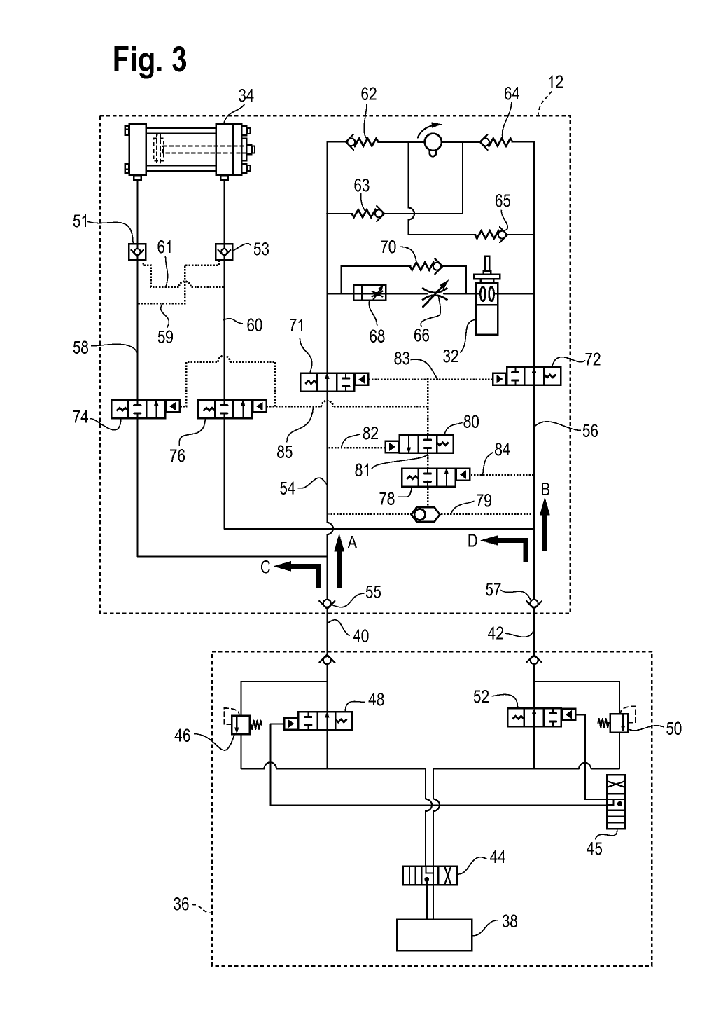

Referring further to FIG. 3, the hydraulic circuit for operating the various motors 28, 32, 34 includes a switch valve 44 adjacent the compressor 38 for selectively directing pressurized hydraulic fluid through either line 40 or 42. Where pressurized fluid from compressor 38 is directed through line 40, the unpressurized fluid is returned to the ROV through line 42 and where pressurized fluid is directed through line 42 the unpressurized fluid returns through line 40. Also positioned on the ROV between the switch valve 44 and the first end of the first line 40 is a first relief valve 46, which is adapted to only allow hydraulic fluid to pass through line 40 in the return direction under a given pressure, such as three hundred psi. Positioned parallel with the first relief valve 46 is a first bypass valve 48 which when open allows fluid to bypass the relief valve 46, and when closed forces returned fluid to pass through the relief valve 46. In similar fashion, between the first switch 44 and the second line 42 is a second relief valve 50 which does not allow hydraulic fluid to return through line 42 to the compressor 38 unless under a given pressure such as three hundred psi. In parallel with the second relief valve 50 is a second bypass valve 52, which when open allows fluid to avoid passing through relief valve 50 and when closed requires that return fluid in line 42 pass through line 50 to reach a reservoir, unnumbered, adjacent the compressor 38. The first and second bypass valves 48, 52 are operable from a manifold control panel 45 on the ROV. The panel 45 may provide for electric or hydraulic controls for opening and closing the valves 48, 50 as the operator chooses. By closing one of the valves 48, 50, the operator will induce a back pressure of 300 psi in a return line and by opening the valves 48, 50 he will release the back pressure.

The second ends of the hydraulic lines 40, 42 connect to the machine 12 by connectors 54, 56 respectively. Aboard the machine 12 are the three motors 28, 32, 34. The two motors 28, 32 that rotate the wire 22 and urge it adjacent the pipe 12 are connected in parallel between a pair of lines 54, 56 each of which is joined to a connector 55, 57 respectively for connecting to the second ends of lines 40 and 42. The connectors 55, 57 are of the type known in the marine industry as an “ROV hot stab,” or “zero leak ROV hot stab.” The hot stab allows the ROV to locally connect or disconnect the hydraulic supply to the tool such that the ROV and the tool can be deployed and recovered independently. The first motor 28 has a plurality of one-way check valves 62, 63, 64, 65 that are configured into a subcircuit 66 between lines 54 and 56 with each of the check valves 62 -65 allowing fluid to flow in one direction only. As depicted in FIG. 3, valves 62 and 64 permit pressurized fluid to flow from line 54, through motor 28 from left to right, to line 56, while valves 62 and 64 block the flow of liquid in the reverse direction. Valves 63 and 65 permit pressurized fluid to flow down line 56, through motor 28, again from left to right, to line 54, while valves 62 and 64 block the flow of liquid in the reverse direction. The motor 28 will therefore operate in the same direction regardless of whether pressurized fluid is directed down line 40 or 42.

The second motor 32 is also positioned between lines 54 and 56, but includes control valves 66, 68 in sequence with the motor 32. As is described in detail in a co-pending application by Kenneth Pierce bearing Ser. No. 12/634,271, the application having a common assignee herewith and which is incorporated herein by reference, valve 66 adjusts flow to the motor 32 to control the speed at which the feed motor 32 causes the diamond wire 22 to be applied against the surface of the pillar 10 in response to detectors for detecting the tension on the diamond wire 22. Valve 68 limits the maximum flow that can be applied to the motor 32. In parallel with the control valves 66, 68, is a one-way valve 70 that bypasses valves 66 and 68 and allows the motor 32 to operate at maximum speed when operating in a reverse direction to withdraw the U-shaped frame 18 from the pillar 10. By directing pressurized hydraulic fluid through lines 40 and 54, the second motor 32 will operate in one direction and by directing pressurized hydraulic fluid through line 42 and line 56, the motor 32 will operate in the opposite direction.

Configured in parallel with lines 54 and 56 are lines 58 and 60, and connected between the distal ends of lines 58 and 60 is the third motor 34. When pressurized fluid is directed down line 58, motor 34 operates in one direction, and when pressurized fluid is directed down line 60, motor 34 operates in the opposite direction. When the fluid is moved in one direction through motor 34, it closes the clamp 16 whereas when hydraulic fluid moves in the opposite direction through the motor 34 the motor opens the clamp 16. Positioned on line 58 near one part of motor 34 is a first cross check valve 51 and positioned on line 60 near the second part of motor 34 is a second cross check valve 53. Each of the cross check valves, 51, 53 has a control or pilot line 61, 59 respectively that connects to the opposite line 58, 60 respectively. The cross check valves 51, 53 retain the pressure in motor 34 applied through one of lines 58, 60 until a pressure is sensed in the opposite line. Accordingly, when pressure in line 58 locks the clamp 16 around the pipe 10, the clamp 16 will remain locked around the pipe by check valve 51 after pressure is released from line 58. It is only when pressure to open the clamp 16 is directed down line 60, and into control line 61 that check valve 51 will open and allow fluid to flow backward out of line 58. Similarly, check valve 53 will retain the clamp 16 in the open condition until pressure is applied to close it. The outer end of line 58 joins with the outer end of line 54 for connecting through connector 55 to line 40 and the outer end of line 60 joins with the outer end of line 56 for connecting through connector 57 to line 42.

A first disconnect valve 71 connects or disconnects line 54 to line 40, and a second disconnect valve 72 connects or disconnects line 56 to line 42. In similar fashion, a third disconnect valve 74 connects or disconnects line 58 to line 40 and a fourth disconnect valve 76 connects or disconnects line 60 to line 42. Valves 71 and 72 operate in unison as a pair such that when both are open they allow hydraulic fluid to flow through both lines 54 and 56 to operate the first and second motors 28, 32. When both valves 71, 72 are closed, hydraulic power to motors 28 and 32 is terminated. Similarly, valves 74 and 76 operate in unison as a pair and are adapted to simultaneously open or simultaneously close. When valves 74 and 76 are opened, hydraulic fluid can pass through lines 58 and 60 in either direction to operate the third motor 34. The disconnect valves are synchronized such that when valves 71 and 72 are open, valves 74 and 76 are closed and when valves 71 and 72 are closed, valves 74 and 76 are open. Accordingly, motors 28 and 32 will operate simultaneously while motor 34 is inoperable and motor 34 is operable only while motors 28 and 32 are inoperable.

The circuit also includes a pair of sensor valves 78, 80 that are driven by bleed lines 79, 81 that connect both sensor valves 78, 80 to pressure applied through either of the connectors 55 or 57. Each of the sensor valves 78, 80 has a detector line 82, 84 respectively, with detector line 82 detecting the pressure in lines 54 and 58 adjacent connector 55 and detector line 82 detecting the pressure in lines 56 and 60 adjacent connector 57. The sensor valves direct pressure in control lines 83 and 85 to the two pairs of disconnect valves 71, 72 and 74, 76. Where either of the detector lines 78, 80 detect the presence of a predetermined back pressure, the sensor valve 78, 80 will direct pressure down the control lines 83, 85 to open the pair of associated valves 71, 72 and close the other pair of associated valves 74, 76. On the other hand, where the sensor valve 78, 80 fails to detect the predetermined back pressure in one of the lines 40, 42 the sensor valves 78, 80 will direct pressure down the control lines 83, 85 to close the first pair of valves 71, 74 and open the second pair of valves 74, 76. Accordingly, the opening and closing of the pairs of valves 71, 72, or 74, 76 will direct fluid to either motors 28 and 32 operating as a pair, or direct fluid to motor 34. In the preferred embodiment, the sensing valves 78, 80 respond to a back pressure detected in one of the lines of at least 250 psi. Accordingly, when one of the relief valves 46, 50, positioned on a return line, causes a back pressure of 300 psi in the return line, the back pressure will be sensed by one of the sensor valves 78, 80 and one of the pair of valves 70, 72 or 74, 76 will be opened and the other pair of valves will be closed. Conversely, where the sensor valves 78, 80 fail to detect a back pressure in a return line of at least 250 psi, the operation of the pairs of valves 71, 72 and 74, 76 will be reversed.

With the circuit in accordance with the present invention, the operation of the motors 28, 32, 34 on the machine 12 can be controlled from the ROV 36. By controlling the switch valve 44, the operator can direct pressurized hydraulic fluid through either lines 40 or 42 and by opening or closing one of the relief valves 46, 50 the operator can selectively direct pressurized fluid through lines 54 and 56 to operate motors 28 and 32, or direct pressurized fluid through lines 58 and 60 to operate motor 34.

While the present invention has been described with respect to a single embodiment, it will be appreciated that many modifications and variations may be made without departing from the spirit and scope of the invention. It is therefore the intent of the appended claims to cover all such modifications and variations that fall within the spirit and scope of the invention.

What is claimed:

1. A remote control fluid circuit for operating a device from a remote location, said device having a first, a second and a third hydraulically operated motors, said first of said motors being a rotary motor operable in only one direction, the second of said motors being a motor operable in two direction, said first and said second motors requiring simultaneous operation, said third of said motors being operable in two directions, and said third of said motors being operable only when said first and said second motors are not operable, said circuit comprising
a source of pressurized hydraulic fluid at said remote location,
a first fluid line connecting said device to said remote location,
a second fluid line connecting said device to said remote location,
a first valve at said remote location for directing pressurized fluid from said source to one of said first and said second lines wherein pressurized fluid directed to said first line is returned in said second line and pressurized fluid directed to said second line is returned in said first line,
a first means at said remote location for forming a back pressure on said first line,
a second means at said remote location for forming a back pressure on said second line,
a first selection means for selectively engaging and disengaging said first means for forming a back pressure,
a second selection means for selectively engaging and disengaging said second means for forming a back pressure,
a first sensor means on said device for sensing a back pressure in said first line,
a second sensor means on said device for sensing a back pressure in said second line,
said first motor and said second motor being configured in parallel between a third line and a fourth line,
a subcircuit having a plurality of one-way valves between said third and fourth lines for directing pressurized fluid through said first motor for rotation in said one direction only,
a fifth and a sixth fluid flow line connected to said third motor,
first switch means for selectively switching fluid flow from said first line to one of said third line and said fifth line,
said first switch means for selectively switching selecting one of said third line and said fifth line in response to a back pressure and selecting the other of said third line and said fifth line in response to the absence of a back pressure,
second switch means for selectively switching fluid flow from said second line to one of said fourth line and said sixth line,
said second switch means for selectively switching selecting one of said fourth line and said sixth line in response to a back pressure and selecting the other of said fourth line and said sixth line in response to the absence of back pressure,
wherein said first and second switch means are simultaneously actuated in response to a back pressure in one of said first lines and said second lines.

2. A remote control circuit for operating a device from a remote location, the device having a first, a second and a third hydraulically operated motors, said first of said motors being a rotary motor operable in only one direction, said second of said motors being a motor operable in two direction, said first and said second motors requiring simultaneous operation, said third of said motors being operable in two directions, and said third of said motors being operable only when said first and said second motors are not operable, said circuit comprising
a source of pressurized hydraulic fluid at said remote location,
a first fluid line and a second fluid line, said first and second fluid lines each having one end connected at said remote location and a second end connected to said device,
a first valve at said remote location for directing pressurized fluid from said source to one of said first and said second fluid lines wherein pressurized fluid directed to said first line is returned in said second line and pressurized fluid directed to said second line is returned in said first line,
means for forming a back pressure on one of said first line and said second line,
means for selectively engaging and disengaging said means for forming a back pressure,
a first sensor means on said device for sensing a back pressure in one of said first line and said second line,
said first motor and said second motor being configured in parallel between a third line and a fourth line,
a subcircuit having a plurality of one-way valves between said third and fourth lines for direction pressurized fluid through said first motor for rotation in said one direction only,
a fifth and a sixth fluid flow line connected to said third motor,
first switch means for selectively connecting fluid flow from said first line to one of said third line and said fifth line,
said first switch means for selectively connecting said fluid flow to said third line in response to a back pressure and selectively connecting said fluid flow to said fifth line in response to the absence of a back pressure, and
wherein said switching means is actuated in one direction in response to a back pressure in one of said first lines and said second lines and actuated in the opposite direction in response to the absence of a back pressure in one of the said first and second lines.

3. A remote control circuit for operating a device from a remote location, the device having a first and a second hydraulically operated motors, each of said motors being operable in two directions, and said second of said motors being operable only when said first motor is not operable, said circuit comprising
a source of pressurized hydraulic fluid at said remote location,
a first fluid line and a second fluid line, said first and second fluid lines and having one end connected at said remote location and a second end connected to said device,
a first valve at said remote location for directing pressurized fluid from said source to one of said first and said second fluid lines wherein pressurized fluid directed to said first line is returned in said second line and pressurized fluid directed to said second line is returned in said first line,
a first means for forming a back pressure on said first line from said first valve,
a first selector means for selectively engaging and disengaging said first means for forming a back pressure,
sensor means on said device for sending a back pressure in said first line,
a third and a fourth fluid flow line connected to said first motor,
a fifth and a sixth fluid flow line connected to said second motor,
first switch means for selectively switching fluid flow from said first line to one of said third line and said fifth line,
said first switch means selecting one of said third line and said fifth line in response to a back pressure and selecting the other of said third line and said fifth line, said fifth line in response to the absence of a back pressure,
said switch means for selectively switching fluid flow from said second line to one of said fourth line and said sixth line,
said second switch means selecting one of said fourth and said sixth line in response to a back pressure and selecting the other of said fourth line and said sixth line in response to the absence of back pressure,
wherein said first and second switch means are simultaneously actuated in response to a back pressure in one of said first lines and said second lines.

4. The remote control circuit in accordance with claim 2 and further comprising a first sensor means on said device for sensing a back pressure in one of said first line and said second line wherein said first sensor causes said switching means to switch a flow of pressurized fluid from said third line to said fifth line in response to the detection of said back pressure.

5. The remote control circuit in accordance with claim 2 and further comprising
second switch means for selectively connecting fluid flows from said second line to one said fourth line and said sixth line,
said second switch means for connecting said fluid flow to said fourth line in response to a back pressure and selecting connecting said fluid flow to said sixth line in response to the absence of back pressure wherein said first and second switch means operate simultaneously and wherein said second switch means operates in unison with said first switch means.
